(19) United States
(12) Patent Application Publication
(10) Pub. No.: US 2014/0168892 A1
(43) Pub. Date: Jun. 19, 2014

(54) SERVER CABINET

(71) Applicants: HONG FU JIN PRECISION INDUSTRY (ShenZhen) CO., LTD., (US); HON HAI PRECISION INDUSTRY CO., LTD., New Taipei (TW)

(72) Inventor: AN-GANG LIANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/726,196

(22) Filed: Dec. 23, 2012

(30) Foreign Application Priority Data
Dec. 13, 2012 (CN) 201210536639.2

(51) Int. Cl. G06F 1/18

(52) U.S. Cl. CPC G06F 1/189; G06F 1/181
USPC 361/679.58; 361/679.02

(57) ABSTRACT

A server cabinet includes a rack, a door rotatably connected to a side of a front end of the rack, a power distribution unit (PDU) fastened to an inner side of the door, and a number of servers mounted in the rack.

### CROSS-REFERENCE TO RELATED APPLICATION

Relevant subject matter is disclosed in a pending U.S. patent application, titled “SERVER CABINET”, filed on Dec. 21, 2012, with the application Ser. No. 13/723,216, attorney docket number US48792, which is assigned to the same assignee as this patent application.

### BACKGROUND

1. Technical Field

The present disclosure relates to a server cabinet.

2. Description of Related Art

In a server cabinet, a power distribution unit (PDU) is generally fastened to a side of a rack of the cabinet, near the servers in the cabinet. When an operator needs to detach the servers, the PDU makes the detachment inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a server cabinet.

FIG. 2 is an enlarged view of a circled portion II of FIG. 1.

FIG. 3 is an enlarged view of a circled portion III of FIG. 1.

FIG. 4 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

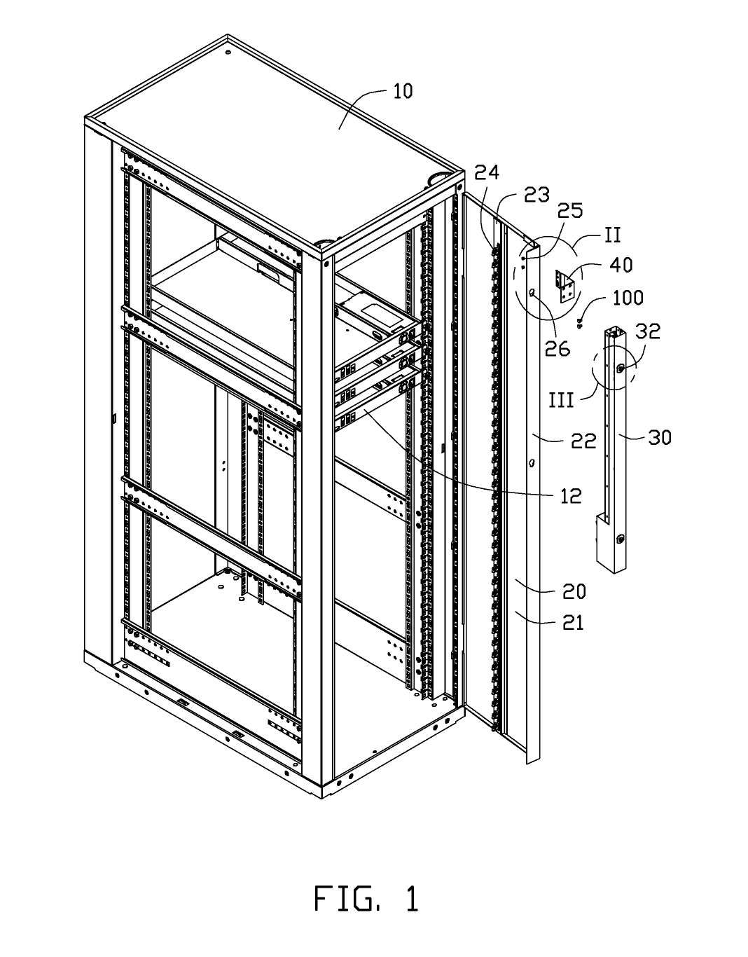

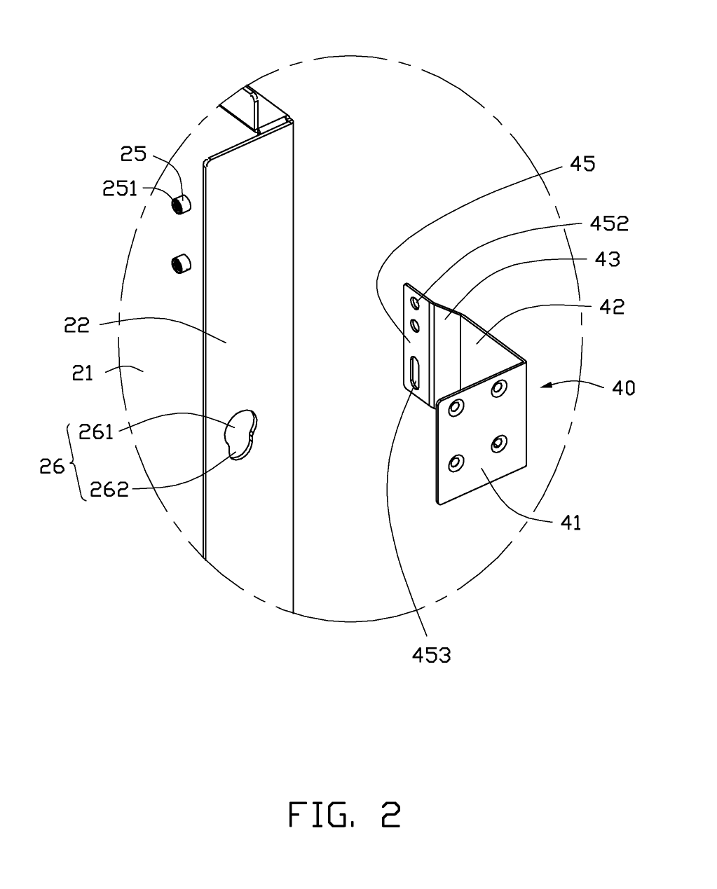

FIGS. 1 and 2 show an exemplary embodiment of a server cabinet. The server cabinet includes a rack 10, a door 20 rotatably connected to a side of a front end of the rack 10, a power distribution unit (PDU) 30, and a position member 40. A plurality of servers 12 is mounted in the rack 10, arranged from top to bottom.

The door 20 includes a main body 21 rotatably connected to the rack 10, and a mounting tab 22 perpendicularly extending inward from a side of the main body 21 away from the rack 10. A bracket 23 extends from a middle of an inner side of the main body 21. A plurality of cable clamps 24 is attached to the bracket 23, arranged from top to bottom. Two protrusions 25 protrude from the inner side of the main body 21, arranged one above the other and near the mounting tab 22. A locking hole 251 is axially defined in each protrusion 25. Two engaging holes 26 are defined in the mounting tab 22. Each engaging hole 26 includes a first hole 261 and a second hole 262 communicating with a bottom of the first hole 261. The first hole 261 and the second hole 262 are both circular, and a radius of the first hole 261 is greater than a radius of the second hole 262.

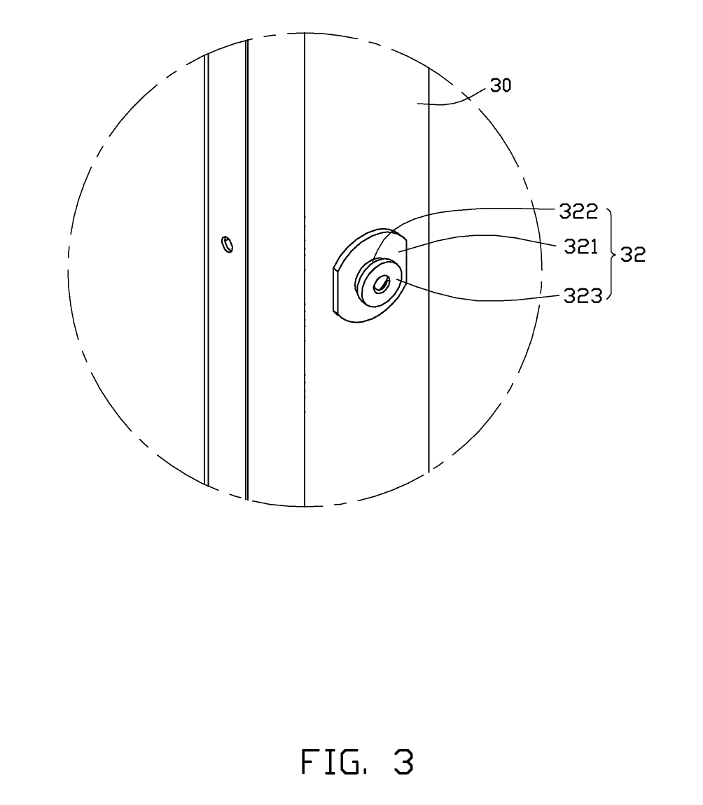

FIG. 3 shows two blocks 32 respectively protruding from upper and lower portions of a first side of the PDU 30 (only the upper block 32 is shown in FIG. 3). Each block 32 includes a connection portion 321 protruding from the PDU 30, a neck 322 protruding from the connection portion 321, and a head 323 formed at a distal end of the neck 322. The neck 322 and the head 323 are both columnar, and a radius of the head 323 is greater than a radius of the neck 322.

FIG. 2 shows the position member 40 including a base plate 41, an extension plate 42 extending from a side of the base plate 41 in a substantially perpendicular manner, a connection plate 43 slantingly extending inward from a side of the extension plate 42 away from the base plate 41, and a fastening plate 45 extending from a side of the connection plate 43 away from the extension plate 42. The fastening plate 45 is substantially perpendicular to the base plate 41. The fastening plate 45 defines two first through holes 452 arranged one above the other, and an elongated second through hole 453 extending from top to bottom and located below the first through holes 452.

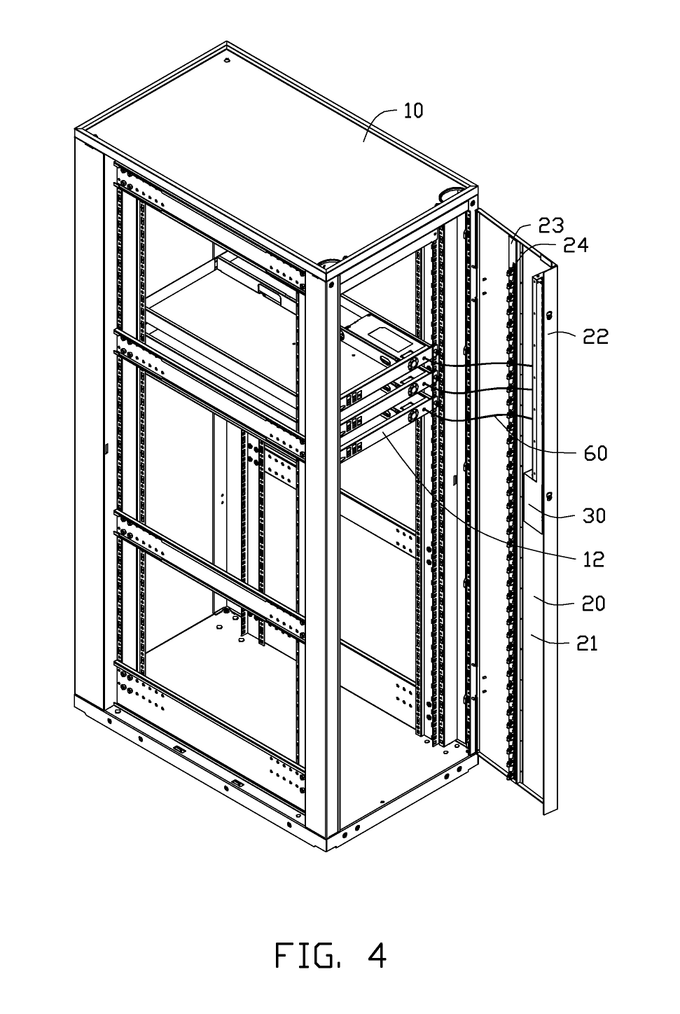

FIG. 4 shows in assembly. The base plate 41 is fastened to the first side of the PDU 30 with screws. The extension plate 42 is located between the PDU 30 and the main body 21. The heads 323 respectively extend through the first holes 261, and the PDU 30 is manipulated down, to engage the necks 322 in the second holes 262. The heads 323 abut an outer side of the mounting tab 22. The connection portions 321 abut an inner side of the mounting tab 22. Two fasteners 100, such as two screws, extend through one of the first through holes 452 and the second through hole 453, and engage in the locking holes 251. The fasteners 100 may extend through the upper first through hole 452 and an upper portion of the second through holes 453 and engage in the locking holes 251, or extend through the lower first through hole 452 and a lower portion of the second through hole 453 and engage in the locking holes 251. A power cable 60 connected to each server 12 is extended through a corresponding cable clamp 24 and connected to a second side of the PDU 30 opposite to the first side of the PDU 30, to avoid the power cable 60 disengaging from the PDU 30 and the server 12 under rotation of the door 20. When the door 20 is rotated to be closed relative to the rack 10, the PDU 30 is received in the rack 10 and near front ends of the servers 12. When the door 20 is open relative to the rack 10, the PDU 30 is located out of the rack 10. Therefore, an operator has a large space to manipulate the servers 12.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A server cabinet, comprising:
a rack;
a door rotatably connected to a side of a front end of the rack;
a power distribution unit (PDU) fastened to an inner side of the door; and
a plurality of servers mounted in the rack.

2. The server cabinet of claim 1, wherein the door comprises a main body rotatably connected to the rack and a mounting tab extending from a side of the main body away from the rack, the mounting tab defines a first hole and a second hole communicating with the first hole, an engaging portion protrudes from the PDU, the engaging portion comprises a neck and a head formed at a distal end of the neck, the head is extended through the first hole and moved toward the second hole, the head abuts an outer side of the mounting tab, the neck engages in the second hole.

3. The server cabinet of claim 2, wherein the first hole and the second hole are circular, a radius of the first hole is greater than a radius of the second hole.

4. The server cabinet of claim 3, wherein the neck and the head are columnar, a radius of the head is greater than a radius of the neck.

5. The server cabinet of claim 2, wherein the engaging portion further comprises a connection portion connected between the PDU and the neck, the connection portion abuts an inner side of the mounting tab.

6. The server cabinet of claim 2, wherein a position member is fastened to the PDU, the position member comprises a fastening plate fastened to an inner side of the main body.

7. The server cabinet of claim 6, wherein the position member comprises a base plate fastened to the PDU, an extension plate extending from a side of the base plate near the main body in a substantially perpendicular manner, and a connection plate slantingly extending inward from a side of the extension plate away from the base plate, the fastening plate extends from a side of the connection plate away from the extension plate.

8. The server cabinet of claim 6, wherein the fastening plate defines two first through holes arranged one above the other, and an elongated second through hole extending from top to bottom and located below the first through holes, two fasteners extend through the upper first through hole and an upper portion of the second through holes and engage in the main body, or extend through the lower first through hole and a lower portion of the second through hole and engage in the main body.

9. The server cabinet of claim 8, wherein two protrusions protrude from the inner side of the main body, a locking hole is defined in each protrusion, the fasteners extend through the fastening plate and engage in the locking holes.

10. The server cabinet of claim 2, wherein a bracket extends from an inner side of the main body, a plurality of cable clamps is attached to the bracket, a power cable connected to each server is extended through a corresponding cable clamp and connected to the PDU.

11. A server cabinet, comprising:
a rack;
a door rotatably connected to a side of a front end of the rack; and
a power distribution unit (PDU) fastened to an inner side of the door.

12. The server cabinet of claim 11, wherein the door comprises a main body rotatably connected to the rack and a mounting tab extending from a side of the main body away from the rack, the mounting tab defines a first hole and a second hole communicating with the first hole, an engaging portion protrudes from the PDU, the engaging portion comprises a neck and a head formed at a distal end of the neck, the head is extended through the first hole and moved toward the second hole, the head abuts an outer side of the mounting tab, the neck engages in the second hole.

13. The server cabinet of claim 12, wherein the first hole and the second hole are circular, a radius of the first hole is greater than a radius of the second hole.

14. The server cabinet of claim 13, wherein the neck and the head are columnar, a radius of the head is greater than a radius of the neck.

15. The server cabinet of claim 12, wherein the engaging portion further comprises a connection portion connected between the PDU and the neck, the connection portion abuts an inner side of the mounting tab.

16. The server cabinet of claim 12, wherein a position member is fastened to the PDU, the position member comprises a fastening plate fastened to an inner side of the main body.

17. The server cabinet of claim 16, wherein the position member comprises a base plate fastened to the PDU, an extension plate extending from a side of the base plate near the main body in a substantially perpendicular manner, and a connection plate slantingly extending inward from a side of the extension plate away from the base plate, the fastening plate extends from a side of the connection plate away from the extension plate.

18. The server cabinet of claim 16, wherein the fastening plate defines two first through holes arranged one above the other, and an elongated second through hole extending from top to bottom and located below the first through holes, two fasteners extend through the upper first through hole and an upper portion of the second through holes and engage in the main body, or extend through the lower first through hole and a lower portion of the second through hole and engage in the main body.

19. The server cabinet of claim 18, wherein two protrusions protrude from the inner side of the main body, a locking hole is defined in each protrusion, the fasteners extend through the fastening plate and engage in the locking holes.
